(19) United States
(12) Patent Application Publication
(10) Pub. No.: US 2026/0245330 A1
(43) Pub. Date: Aug. 20, 2026

(54) INFORMATION PROCESSING APPARATUS, INFORMATION PROCESSING METHOD, AND RECORDINGMEDIUM

(71) Applicant: NEC Corporation, Tokyo (JP)

(72) Inventors: Tomokazu KANEKO, Tokyo (JP); Soma SHIRAISHI, Tokyo (JP); Ryosuke SAKAI, Tokyo (JP); Ryo NAKAO, Tokyo (JP)

(73) Assignee: NEC Corporation, Tokyo (JP)

(21) Appl. No.: 19/445,908

(22) Filed: Jan. 12, 2026

(30) Foreign Application Priority Data
Feb. 17, 2025 (JP) 2025-023696

(51) Int. Cl. G06V 10/25; G06V 10/74

(52) U.S. Cl. CPC G06V 10/25; G06V 10/761; G06V 2201/07

(57) ABSTRACT

An information processing apparatus includes one or more memories storing instructions and one or more processors configured to execute the instructions to: generate one or a plurality of first attention regions based on an object representation of each object included in a target image, the object representation extracted by using an extraction model; generate one or a plurality of second attention regions from the target image by using a pre-learned model; estimate a correspondence relationship between the first attention region and the second attention region; calculate a loss with reference to the first attention region and the second attention region relevant to each other; and cause the extraction model to learn with reference to the loss.

This application is based upon and claims the benefit of priority from Japanese Patent Application No. 2025-023696, filed on February 17, 2025, the disclosure of which is incorporated herein in its entirety by reference.

### TECHNICAL FIELD

The present disclosure relates to an information processing apparatus, an information processing method, and a recording medium.

### BACKGROUND ART

For example, JP 2023-104705 A discloses a learning device that includes a supervised learning unit and a self-supervised learning unit and learns an object detection network for detecting an object from target image data.

### SUMMARY

An exemplary object of the present disclosure is to provide a technique capable of efficiently learning a model for extracting an object.

According to an exemplary aspect of the present disclosure, an information processing apparatus includes first generation means for extracting an object representation of each object included in a target image and generating one or a plurality of first attention regions based on the object representation, second generation means for generating one or a plurality of second attention regions from the target image by using a pre-learned model, association means for estimating a correspondence relationship between the first attention region and the second attention region, loss calculation means for calculating a loss with reference to the first attention region and the second attention region relevant to each other, and learning means for causing the first generation means to learn with reference to the loss.

According to another exemplary aspect of the present disclosure, an information processing method includes, by one or a plurality of processors, extracting an object representation of each object included in a target image by using an extraction model and generating one or a plurality of first attention regions based on the object representation, generating one or a plurality of second attention regions from the target image by using a pre-learned model, estimating a correspondence relationship between the first attention region and the second attention region, calculating a loss with reference to the first attention region and the second attention region relevant to each other, and causing the extraction model to learn with reference to the loss.

According to still another exemplary aspect of the present disclosure, a non-transitory recording medium records a program causing a computer to function as an information processing apparatus, and the program causes the computer to function as first generation means for extracting an object representation of each object included in a target image and generating one or a plurality of first attention regions based on the object representation, second generation means for generating one or a plurality of second attention regions from the target image by using a pre-learned model, association means for estimating a correspondence relationship between the first attention region and the second attention region, loss calculation means for calculating a loss with reference to the first attention region and the second attention region relevant to each other, and learning means for causing the first generation means to learn with reference to the loss.

### BRIEF DESCRIPTION OF THE DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a diagram for describing a processing example in the information processing system according to the present disclosure;

FIG. 5 is a diagram for describing a flow of processing in the information processing system according to the present disclosure;

FIG. 6 is a diagram for describing a configuration example and processing example in the information processing system according to the present disclosure;

FIG. 7 is a diagram for describing a configuration example and processing example in the information processing system according to the present disclosure;

FIG. 8 is a diagram for describing a configuration example and processing example in the information processing system according to the present disclosure;

FIG. 9 is a diagram for describing a configuration example and processing example in the information processing system according to the present disclosure;

FIG. 10 is a block diagram illustrating a configuration of an information processing system according to the present disclosure; and

FIG. 11 is a block diagram illustrating a configuration of a computer that functions as the information processing apparatus according to the present disclosure.

### EXAMPLE EMBODIMENT

Hereinafter, example embodiments of the present disclosure will be exemplified. However, the present disclosure is not limited to the following example embodiments, and various modifications may be made within the scope described in the claims. For example, example embodiments obtained by appropriately combining techniques (some or all of objects or methods) adopted in the following example embodiments may also fall within the scope of the present disclosure. Example embodiments obtained by appropriately omitting some of the techniques adopted in the following example embodiments may also fall within the scope of the present disclosure. Effects mentioned in the following example embodiments are examples of effects expected in the example embodiments, and do not define the extension of the present disclosure. That is, example embodiments that do not exert the effects mentioned in the following example embodiments may also fall within the scope of the present disclosure.

### First Example Embodiment

A first example embodiment, which is an example of the example embodiments of the present disclosure, will be described in detail with reference to the drawings. The present example embodiment is a basic form of the individual example embodiments to be described below. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing Apparatus 1

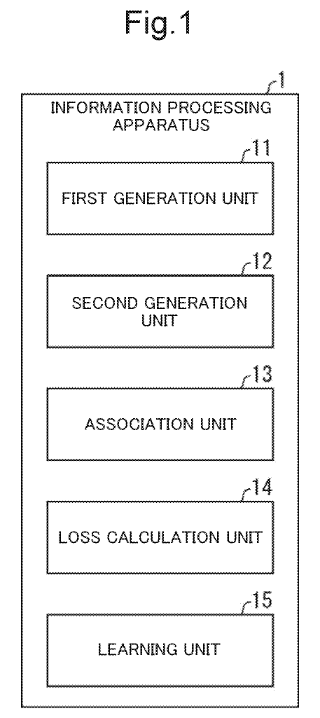

A configuration of an information processing apparatus 1 according to the present example embodiment will be described with reference to FIG. 1. FIG. 1 is a block diagram illustrating the configuration of the information processing apparatus 1. As illustrated in FIG. 1, the information processing apparatus 1 includes a first generation unit 11, a second generation unit 12, an association unit 13, a loss calculation unit 14, and a learning unit 15.

### First Generation Unit 11

The first generation unit 11 acquires a target image, extracts an object representation of each object included in the target image, and generates one or a plurality of first attention regions based on the object representation. Here, the object representation is a numerical representation of each object included in the target image, and is represented as a vector as an example. As an example, the object representation is derived with reference to a feature amount map obtained from the target image. The first attention region is information generated with reference to the object representation, and is represented as one or a plurality of first attention region maps as an example. As an example, the first generation unit 11 can be configured to include: - an encoder to which the target image is input; and - an extraction model that extracts the object representation of each object with reference to an output of the encoder, but this does not limit the present example embodiment.

### Second Generation Unit 12

The second generation unit 12 generates one or a plurality of second attention regions from the target image by using a pre-learned model. Here, the second attention region is information generated with reference to the target image, and is represented as one or a plurality of second attention region maps as an example.

Although a specific example of the pre-learned model does not limit the present example embodiment, various learned models such as DINO, vision transformer (ViT), and segment anything model (SAM) can be used.

### Association Unit 13

The association unit 13 estimates a correspondence relationship between each of the one or the plurality of first attention regions generated by the first generation unit 11 and the one or the plurality of second attention regions generated by the second generation unit 12. As an example, the association unit 13 may be configured to calculate a similarity between each of the one or the plurality of first attention regions and each of the one or the plurality of second attention regions, and estimate a correspondence relationship between the first attention region and the second attention region with reference to the similarity. However, this does not limit the present example embodiment.

### Loss Calculation Unit 14

The loss calculation unit 14 calculates a loss with reference to the first attention region and the second attention region associated with each other by the association unit 13. A specific example of a loss function referred to by the loss calculation unit 14 does not limit the present example embodiment, and as an example, a loss function configured in such a way that a value of the loss becomes smaller as a degree of difference between the first attention region and the second attention region becomes smaller can be used.

### Learning Unit 15

The learning unit 15 causes the first generation unit 11 to learn with reference to the loss calculated by the loss calculation unit 14. As an example, the learning unit 15 updates a parameter of the extraction model that is used by the first generation unit 11 and is used to extract the object representation of each object included in the target image with reference to the loss calculated by the loss calculation unit 14.

### Effects of Information Processing Apparatus 1

As described above, in the information processing apparatus 1, a configuration including

the first generation unit 11 for extracting an object representation of each object included in a target image and generating one or a plurality of first attention regions based on the object representation,

the second generation unit 12 for generating one or a plurality of second attention regions from the target image by using a pre-learned model,

the association unit 13 for estimating a correspondence relationship between the first attention region and the second attention region,

the loss calculation unit 14 for calculating a loss with reference to the first attention region and the second attention region relevant to each other, and

the learning unit 15 for causing the first generation unit 11 to learn with reference to the loss is adopted. As described above, in the information processing apparatus 1, the first attention region generated by the first generation unit 11 and the second attention region generated by the second generation unit 12 are associated with each other, and in this state, the loss is calculated with reference to these attention regions, and the first generation unit 11 is caused to learn with reference to the calculated loss.

Thus, according to the above configuration, the first generation unit 11 can be caused to efficiently learn by using knowledge based on the pre-learned model. In other words, according to the above configuration, it is possible to cause a model for extracting an object to efficiently learn.

### Flow of Information Processing Method S1

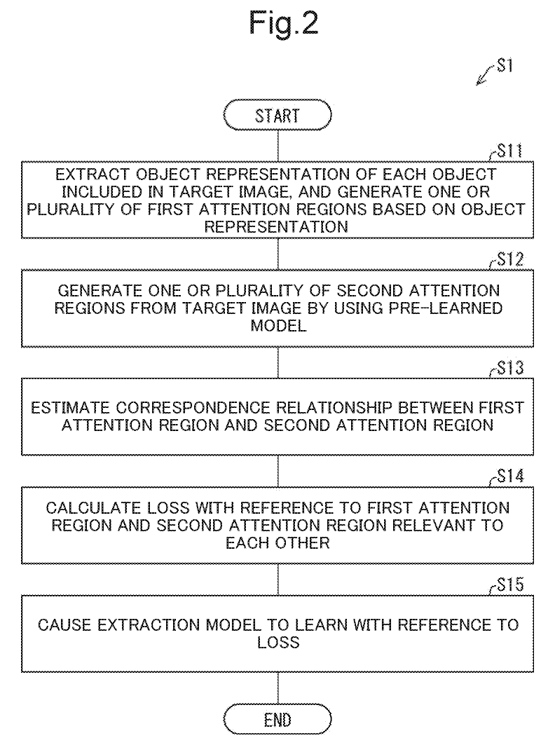

Subsequently, a flow of an information processing method S1 according to the present example embodiment will be described with reference to FIG. 2. FIG. 2 is a flowchart illustrating the flow of the information processing method S1. As illustrated in FIG. 2, the information processing method S1 includes a step (process) S11 of generating a first attention region, a step (process) S12 of generating a second attention region, a step (process) S13 of estimating a correspondence relationship, a step (process) S14 of calculating a loss, and a step (process) S15 of causing an extraction model to learn.

### Step S11

In Step S11, the first generation unit 11 acquires a target image, extracts an object representation of each object included in the target image by using an extraction model, and generates one or a plurality of first attention regions based on the object representation. The first generation unit 11 has been more specifically described above, and thus is not described here.

### Step S12

In Step S12, the second generation unit 12 generates one or a plurality of second attention regions from the target image by using a pre-learned model. The second generation unit 12 has been more specifically described above, and thus is not described here.

### Step S13

In Step S13, the association unit 13 estimates a correspondence relationship between each of the one or the plurality of first attention regions generated by the first generation unit 11 and the one or the plurality of second attention regions generated by the second generation unit 12. The association unit 13 has been more specifically described above, and thus is not described here.

### (Step S14

In Step S14, the loss calculation unit 14 calculates a loss with reference to the first attention region and the second attention region associated with each other by the association unit 13. The loss calculation unit 14 has been more specifically described above, and thus is not described here.

### Step S15

In Step S15, the learning unit 15 causes the extraction model to learn with reference to the loss. The learning unit 15 has been more specifically described above, and thus is not described here.

### Effect of Information Processing Method S1

As described above, in the information processing method S1, a configuration including extracting an object representation of each object included in a target image by using an extraction model and generating one or a plurality of first attention regions based on the object representation, generating one or a plurality of second attention regions from the target image by using a pre-learned model, estimating a correspondence relationship between the first attention region and the second attention region, calculating a loss with reference to the first attention region and the second attention region relevant to each other, and causing the extraction model to learn with reference to the loss is adopted. According to the above configuration, an effect is provided similar to that of the information processing apparatus 1.

### Second Example Embodiment

A second example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment.

That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100A

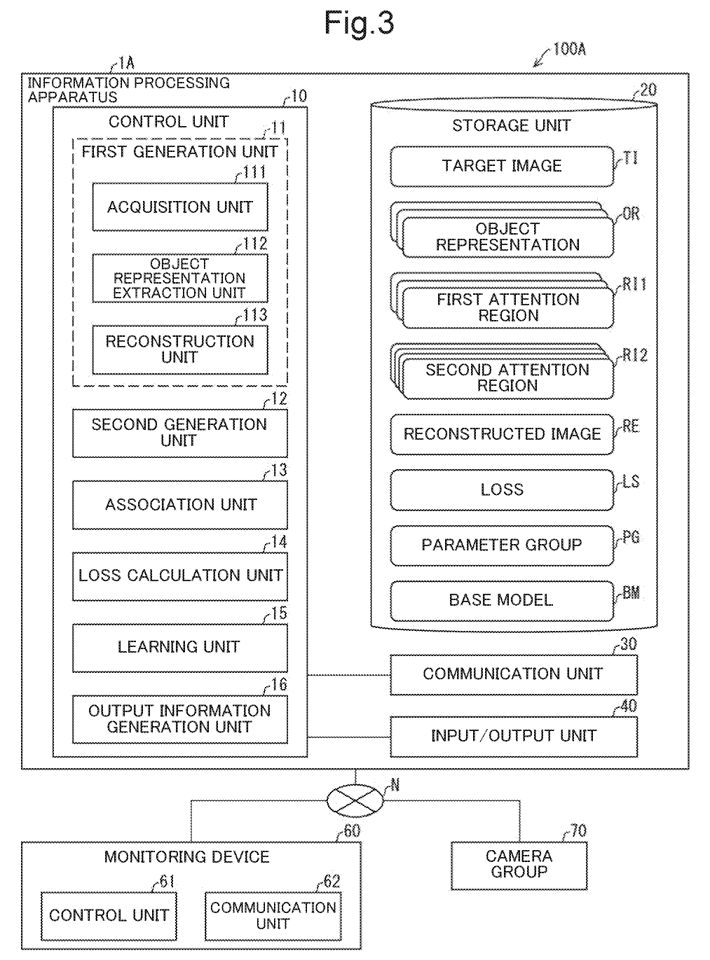

A configuration of an information processing system 100A according to the present example embodiment will be described with reference to FIG. 3. FIG. 3 is a block diagram illustrating the configuration of the information processing system 100A. As illustrated in FIG. 3, the information processing system 100A includes an information processing apparatus 1A, and a monitoring device 60 and a camera group 70 that are connected to the information processing apparatus 1A via a network N. Here, a specific configuration of the network N does not limit the present example embodiment, and as an example, it is possible to use a wireless Local Area Network (LAN), a wired LAN, a Wide Area Network (WAN), a public line network, a mobile data communication network, or a combination of these networks.

### Camera Group 70

The camera group 70 includes one or a plurality of cameras. As an example, in a case where the monitoring device 60 is configured as a traffic monitoring device, these cameras capture images of roads, vehicles, and the like. As another example, in a case where the monitoring device 60 is configured as a security monitoring device in a building, these cameras capture images of people, vehicles, and the like inside or outside the building. The image captured by the camera group 70 is supplied to the information processing apparatus 1A as an example.

### Monitoring Device 60

Generally speaking, the monitoring device 60 acquires an object representation or a reconstructed image extracted by the information processing apparatus 1A from an image captured by the camera group 70, and executes a target monitoring process with reference to the acquired object representation and reconstructed image. As illustrated in FIG. 3, the monitoring device 60 includes a control unit 61 and a communication unit 62. The communication unit 62 receives the object representation and the reconstructed image from the information processing apparatus 1A. The control unit 61 performs a traffic monitoring process with reference to the object representation and the reconstructed image, which are acquired from the information processing apparatus 1A. As another example, the control unit 61 performs a security monitoring process in a building with reference to the object representation and the reconstructed image, which are acquired from the information processing apparatus 1A.

Although the monitoring device 60 is exemplified as a device separate from the information processing apparatus 1A in the present example embodiment, this does not limit the present example embodiment. A configuration in which a control unit of the information processing apparatus 1A includes the function as the control unit 61 included in the monitoring device 60 may be made.

### Configuration of Information Processing Apparatus 1A

Subsequently, a configuration of the information processing apparatus 1A according to the present example embodiment will be described with reference to FIG. 3. As illustrated in FIG. 3, the information processing apparatus 1A includes a control unit 10, a storage unit 20, a communication unit 30, and an input/output unit 40.

### Communication Unit 30

The communication unit 30 communicates with a device outside the information processing apparatus 1A. As an example, the communication unit 30 communicates with the camera group 70. The communication unit 30 supplies an image supplied from the camera group 70 to the control unit 10. The communication unit 30 communicates with the monitoring device 60. The communication unit 30 supplies an object representation and a reconstructed image derived by the control unit 10 to the monitoring device 60.

### Input/Output Unit 40

The input/output unit 40 includes at least one of input/output devices such as a keyboard, mouse, a display, a printer, and a touch panel. Alternatively, the input/output unit 40 may be connected to an input/output device such as a keyboard, a mouse, a display, a printer, or a touch panel. This configuration allows the input/output unit 40 to receive inputs of various types of information to the information processing apparatus 1A from the connected input equipment. The input/output unit 40 also outputs various types of information to the connected output equipment under control of the control unit 10. Examples of the input/output unit 40 include an interface such as, for example, a Universal Serial Bus (USB).

### Storage Unit 20

The storage unit 20 stores various types of data to be referred to by the control unit 10 and various types of data generated by the control unit 10. As an example, the storage unit 20 stores a target image TI, an object representation OR, a first attention region RI1, a second attention region RI2, a reconstructed image RE, a loss LS, a parameter group PG, and a base model BM. As an example, the target image TI may or may not be an image supplied from the camera group 70. The target image TI includes at least one of an image (learning data) used for a learning process by the learning unit 15 to be described later in a learning phase, and an image (inference data) referred to for extracting an object representation by an object representation extraction unit 112 in an inference phase.

The object representation OR is a representation extracted (generated) by the object representation extraction unit 112 to be described later, and is a numerical representation of each object included in the target image TI. The object representation OR is represented as a vector as an example.

The first attention region RI1 is information generated by the object representation extraction unit 112 to be described later with reference to the object representation OR, and is represented as one or a plurality of first attention region maps as an example. The second attention region RI2 is information generated by the second generation unit 12 to be described later with reference to the target image TI by using the base model BM, and is represented as one or a plurality of second attention region maps as an example. Specific examples of the first attention region RI1 and the second attention region RI2 will be described later.

The reconstructed image RE is an image generated by a reconstruction unit 113 to be described later, and is an image reconstructed with reference to an object representation of each object included in the target image TI. The loss LS is calculated by a loss calculation unit 14 to be described later using a loss function. Specific examples of the reconstructed image RE and the loss LS will be described later.

The parameter group PG includes parameters defining various models used by the control unit 10. As an example, the parameter group PG includes one or a plurality of parameters that define an encoder used by the object representation extraction unit 112; one or a plurality of parameters that define an extraction model that is used by the object representation extraction unit 112 and extracts an object representation from an output of the encoder, one or a plurality of parameters that define a decoder used by the reconstruction unit 113; and the like. At least some of these parameters are targets of the learning process (update process) by the learning unit 15 to be described later.

The base model BM is a pre-learned model used in a case where the second generation unit 12 to be described later generates one or a plurality of second attention regions RI2 from the target image TI. Although a specific example of the base model BM does not limit the present example embodiment, various learned models such as DINO, vision transformer (ViT), and segment anything model (SAM) can be used.

### Control Unit 10

As illustrated in FIG. 3, the control unit 10 includes a first generation unit 11, a second generation unit 12, an association unit 13, a loss calculation unit 14, a learning unit 15, and an output information generation unit 16.

### First Generation Unit 11

The first generation unit 11 acquires a target image TI, extracts an object representation OR of each object included in the target image TI, and generates one or a plurality of first attention regions RI1 based on the object representation OR. As illustrated in FIG. 3, the first generation unit 11 includes an acquisition unit 111, the object representation extraction unit 112, and the reconstruction unit 113.

### Acquisition Unit 111

The acquisition unit 111 acquires a target image TI. The acquisition unit 111 may be configured to acquire the target image TI from the above-described camera group 70 via the communication unit 30, or may be configured to acquire the target image TI stored in the storage unit 20.

### Object Representation Extraction Unit 112

The object representation extraction unit 112 extracts an object representation OR of each object included in the target image TI.

As an example, the object representation extraction unit 112 may be configured to include an encoder to which a target image TI is input and which generates a feature amount map of the target image TI, and an extraction model that extracts an object representation OR of each object included in the target image TI with reference to an output (feature amount map) of the encoder. Here, a convolutional neural network (CNN) may be used as the encoder. As the extraction model, an attention model, more specifically, an SLOT attention model may be used. However, these examples do not limit the present example embodiment. The object representation extraction unit 112 may be configured to generate one or a plurality of first attention regions RI1 with reference to the extracted object representation OR. More specifically, the object representation extraction unit 112 may be configured to generate one or a plurality of mask images (attention masks) as the one or the plurality of first attention region maps with reference to one or a plurality of object representations OR, and represent the one or the plurality of first attention regions RI1 by the attention masks.

### Reconstruction Unit 113

The reconstruction unit 113 reconstructs each object with reference to the object representation of each object, which is extracted by the object representation extraction unit 112. As an example, the reconstruction unit 113 generates a reconstructed image RE including each of reconstructed objects. The reconstruction unit 113 may be configured as a decoder to which the object representation of each object is input and which outputs the reconstructed image RE. The reconstruction unit 113 may be configured to generate one or a plurality of first attention regions RI1 with reference to the object representation OR. More specifically, the reconstruction unit 113 may be configured to generate a mask image (decoder mask) as the one or the plurality of first attention region maps with reference to one or a plurality of object representations OR, and represent the one or the plurality of first attention regions RI1 by the decoder mask.

### Second Generation Unit 12

The second generation unit 12 generates one or a plurality of second attention regions RI2 from the target image TI by using the pre-learned base model BM. As an example, the second generation unit 12 may be configured to generate one or a plurality of second attention region maps with reference to the target image TI in such a way that the one or the plurality of second attention regions RI2 are represented by the second attention region maps.

### Association Unit 13

The association unit 13 estimates a correspondence relationship between each of the one or the plurality of first attention regions RI1 generated by the first generation unit 11 and the one or the plurality of second attention regions RI2 generated by the second generation unit 12. As an example, the association unit 13 may be configured to calculate a similarity between each of the one or the plurality of first attention regions RI1 and each of the one or the plurality of second attention regions RI2, and estimate a correspondence relationship between the first attention region RI1 and the second attention region RI2 with reference to the similarity.

More specifically, the association unit 13 may calculate a cosine similarity between K (K is a natural number) pieces of attention region maps generated by the first generation unit 11 and K’ (K’ is a natural number) pieces of attention region maps generated by the second generation unit 12, and determine a correspondence relationship between the first attention region RI1 and the second attention region RI2 in such a way that the sum of the cosine similarities is maximized. A Hungarian algorithm may be used to derive the correspondence relationship. However, this does not limit the present example embodiment.

### Loss Calculation Unit 14

The loss calculation unit 14 calculates a loss with reference to the first attention region and the second attention region associated with each other by the association unit 13. As an example, the loss calculation unit 14 calculates the loss by using a loss function configured in such a way that the value of the loss becomes smaller as the degree of difference between the first attention region and the second attention region becomes smaller.

### Learning Unit 15

The learning unit 15 causes the first generation unit 11 to learn with reference to the loss calculated by the loss calculation unit 14. As an example, the learning unit 15 updates at least one of parameters of the encoder used by the object representation extraction unit 112, the extraction model used by the object representation extraction unit 112, and the decoder constituting the reconstruction unit 113, with reference to the loss calculated by the loss calculation unit 14. As an example, the learning unit 15 updates these parameters in such a way that the loss calculated by the loss calculation unit 14 becomes smaller.

### Output Information Generation Unit 16

The output information generation unit 16 generates output information including information generated (extracted) by the control unit 10, and outputs the generated output information to the outside via the communication unit 30 or the input/output unit 40. As an example, the output information generation unit 16 may be configured to generate output information including the object representation extracted by the object representation extraction unit 112 and supply the output information to the monitoring device 60 via the communication unit 30. The output information may include the reconstructed image RE generated by the reconstruction unit 113, or may include information generated by other configurations included in the control unit 10.

### Specific Configuration Example and Processing Example 1

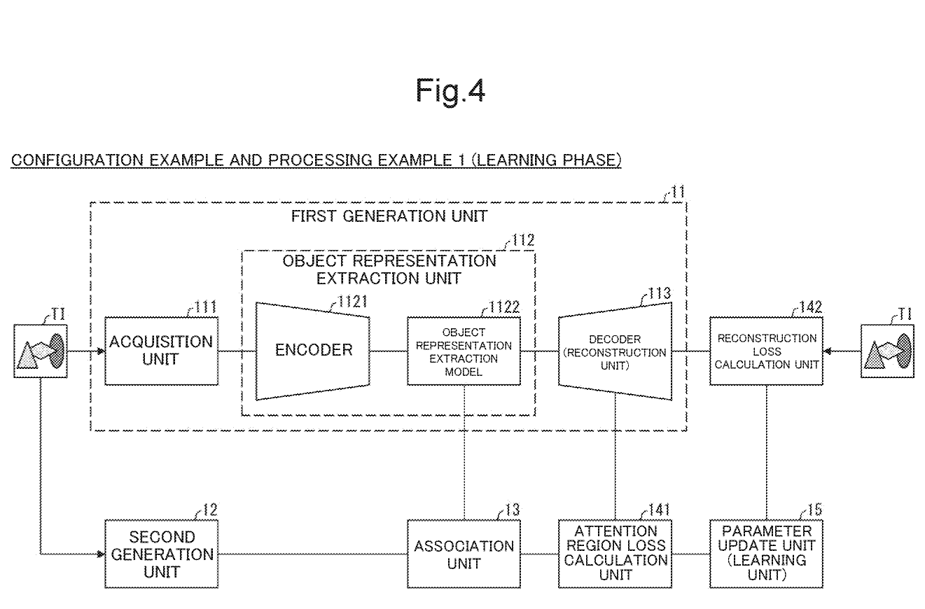

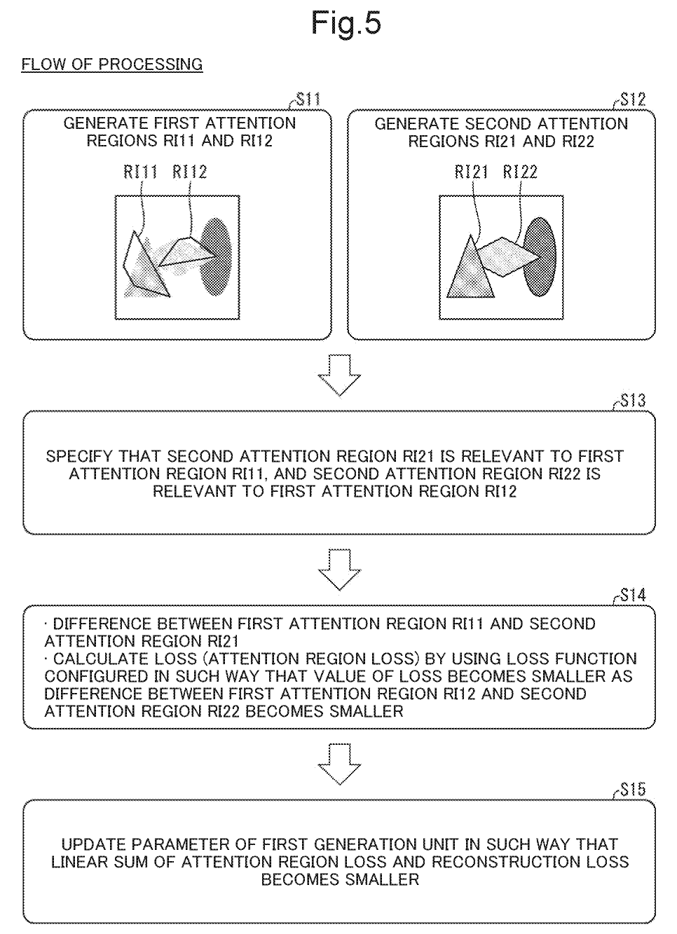

Subsequently, a specific configuration example and processing example 1 of the information processing apparatus 1A will be described with reference to FIGS. 4 and 5. FIG. 4 is a diagram illustrating a specific configuration example and a processing example 1 of the information processing apparatus 1A in a learning phase. FIG. 5 is a diagram schematically illustrating an example of a flow of processing by the information processing apparatus 1A in the learning phase.

As illustrated in FIG. 4, first, a target image TI is acquired by the acquisition unit 111 included in the first generation unit 11. The acquired target image TI is input to an encoder 1121 included in the object representation extraction unit 112. An object representation extraction model (extraction model) 1122 extracts one or a plurality of object representations OR with reference to an output of the encoder 1121. The object representation extraction unit 112 generates K (K is a natural number) pieces of first attention region maps (attention masks in this example) based on the one or the plurality of object representations OR, and supplies the generated first attention region maps to the association unit 13.

The one or the plurality of object representations OR extracted by the extraction model 1122 are supplied to a decoder (reconstruction unit) 113, and a reconstructed image RE is generated (reconstructed) from the object representation OR by the decoder 113.

On the other hand, the target image TI is also supplied to the second generation unit 12, and the second generation unit 12 generates K’ (K’ is a natural number) pieces of second attention region maps by using the base model BM and supplies the generated second attention region maps to the association unit 13.

Step S11 in FIG. 5 schematically illustrates first attention regions RI11 and RI12 indicated by the first attention region map generated by the first generation unit 11. Step S12 in FIG. 5 schematically illustrates second attention regions RI21 and RI22 indicated by the second attention region map generated by the second generation unit 12.

The association unit 13 illustrated in FIG. 4 estimates a correspondence relationship between the first attention regions RI11 and RI12 generated by the first generation unit 11, and the second attention regions RI21 and RI22 generated by the second generation unit 12. As an example, the association unit 13 estimates the correspondence relationship by using the cosine similarity and the Hungarian algorithm described above.

Step S13 in FIG. 5 illustrates that, as an example, the association unit 13 specifies that the second attention region RI21 is relevant to the first attention region RI11, and the second attention region RI22 is relevant to the first attention region RI12.

A attention region loss calculation unit 141 illustrated in FIG. 4 calculates a loss with reference to the first attention region and the second attention region associated with each other by the association unit 13. As an example, as illustrated in Step S14 in FIG. 5, the loss calculation unit 14 calculates the loss (attention region loss) by using a loss function configured in such a way that the value of the loss becomes smaller as a difference between the first attention region RI11 and the second attention region RI21 and a difference between the first attention region RI12 and the second attention region RI22 becomes smaller. For example, the L2 norm may be used as the loss function. The attention region loss calculated by the attention region loss calculation unit 141 is supplied to a parameter update unit (learning unit) 15.

On the other hand, a reconstruction loss calculation unit 142 illustrated in FIG. 4 calculates a loss based on a difference between the reconstructed image RE generated by the decoder 113 and the target image TI. As an example, the loss (reconstruction loss) is calculated by using a loss function configured in such a way that the value of the loss becomes smaller as the difference between the reconstructed image RE and the target image TI becomes smaller.

Then, as illustrated in Step S15 in FIG. 5, the parameter update unit (learning unit) 15 updates a parameter of each model used by the first generation unit 11 in such a way that the linear sum of the attention region losses calculated by the attention region loss calculation unit 141 and the reconstruction loss calculated by the reconstruction loss calculation unit 142 becomes smaller.

As described above, the information processing apparatus 1A includes the first generation unit 11 for extracting an object representation of each object included in a target image TI and generating one or a plurality of first attention regions (K pieces of attention region maps) based on the object representation, the second generation unit 12 for generating one or a plurality of second attention regions (K’ pieces of attention region maps) from the target image TI by using a pre-learned model (base model BM), the association unit 13 for estimating a correspondence relationship between the first attention region and the second attention region, the loss calculation unit 14 for calculating a loss with reference to the first attention region and the second attention region relevant to each other, and the learning unit 15 for causing the first generation unit 11 to learn with reference to the loss. As described above, in the information processing apparatus 1A, the first attention region generated by the first generation unit 11 and the second attention region generated by the second generation unit 12 are associated with each other, and in this state, the loss is calculated with reference to these attention regions, and the first generation unit 11 is caused to learn with reference to the calculated loss.

Therefore, according to the above configuration, by using knowledge based on the pre-learned base model BM, in other words, by transferring the knowledge based on the base model BM, it is possible to accelerate convergence of learning and cause the first generation unit 11 to efficiently learn. As an example, according to the above configuration, it is possible to cause the extraction model for extracting an object to efficiently learn. More specifically, as an example, it is possible to efficiently construct a world model that achieves amodal segmentation (hidden region estimation), future prediction, and the like. By using the present example for a monitoring process by the monitoring device 60, it is possible to detect and track a vehicle and a person without manual correct answer by simply installing a monitoring camera (camera group 70) and collecting a video.

### Specific Configuration Example and Processing Example 2

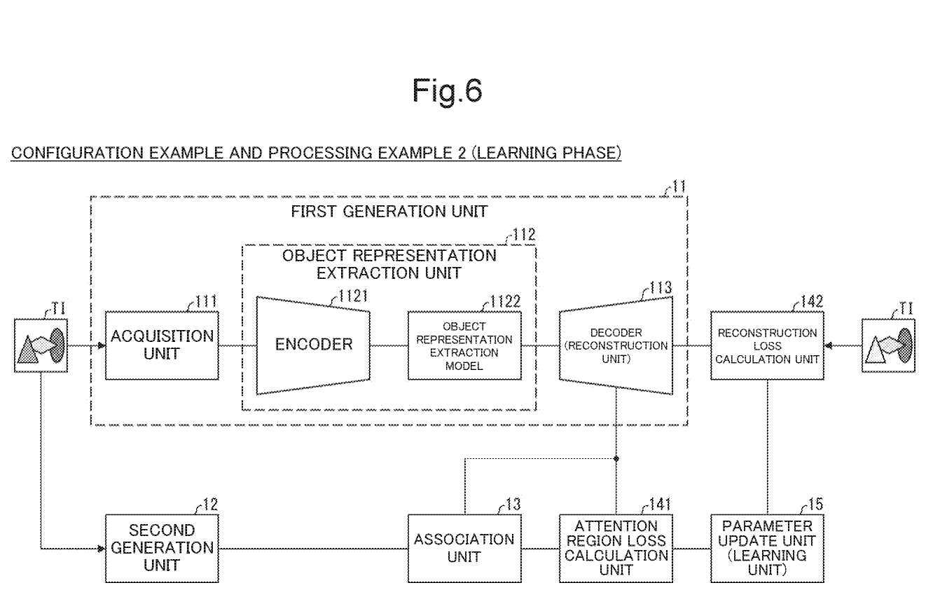

Subsequently, a specific configuration example and processing example 2 of the information processing apparatus 1A will be described with reference to FIG. 6. FIG. 6 is a diagram illustrating the specific configuration example and processing example 2 of the information processing apparatus 1A in the learning phase.

As illustrated in FIG. 6, in the present example, the decoder (reconstruction unit) 113 generates K (K is a natural number) pieces of first attention region maps (decoder masks in the present example), and supplies the generated first attention region maps to the association unit 13. On the other hand, in the present example, the first attention region map is not supplied from the object representation extraction unit 112. Other processes are similar to the configuration example and processing example 1 described above, and thus repetitive description will be omitted. Also with the configuration of the present example, it is possible to cause the first generation unit 11 to efficiently learn by using the knowledge based on the pre-learned base model BM.

### Specific Configuration Example and Processing Example 3

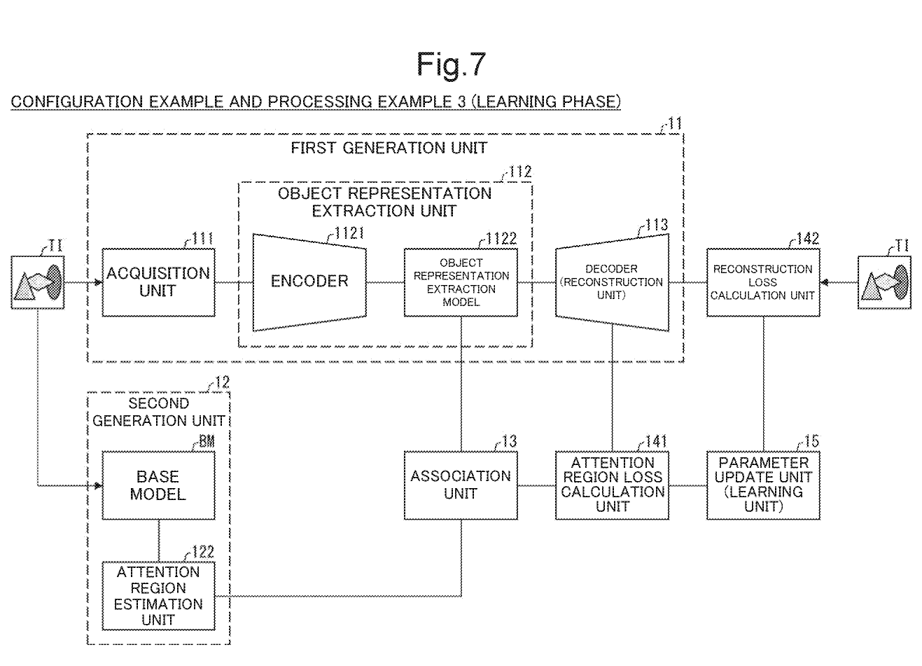

Subsequently, a specific configuration example and processing example 3 of the information processing apparatus 1A will be described with reference to FIG. 7. FIG. 7 is a diagram illustrating the specific configuration example and processing example 3 of the information processing apparatus 1A in the learning phase.

As illustrated in FIG. 7, in the present example, the second generation unit 12 includes a base model BM and a attention region estimation unit 122. Here, the attention region estimation unit 122 estimates the one or the plurality of second attention regions with reference to the output of the base model BM to which the target image TI is input. As an example, the attention region estimation unit 122 generates K’ (K’ is a natural number) pieces of second attention region maps with reference to the output from an intermediate layer or an output layer of the base model BM to which the target image TI is input, and supplies the generated second attention region maps to the association unit 13.

More specifically, the attention region estimation unit 122 may be configured to estimate K’ pieces of attention region maps by dividing a feature map (h×w×d dimensions) acquired from the base model BM into a predetermined number of clusters K’ by the K-means method or the like. The attention region estimation unit 122 may determine the number of clusters K’ based on the number of objects K determined by the object representation extraction unit 112. As an example, K’=K may be set.

Other processes are similar to the configuration example and processing example 1 described above, and thus repetitive description will be omitted. Also with the configuration of the present example, it is possible to cause the first generation unit 11 to efficiently learn by using the knowledge based on the pre-learned base model BM.

### Specific Configuration Example and Processing Example 4

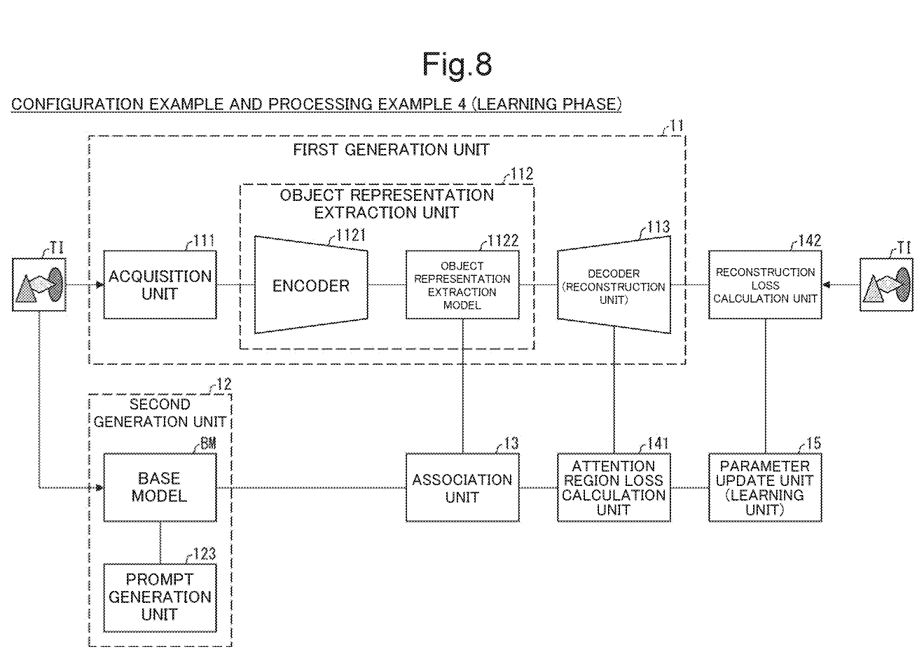

Subsequently, a specific configuration example and processing example 4 of the information processing apparatus 1A will be described with reference to FIG. 8. FIG. 8 is a diagram illustrating the specific configuration example and processing example 4 of the information processing apparatus 1A in the learning phase.

As illustrated in FIG. 8, in the present example, the second generation unit 12 includes a base model BM and a prompt generation unit 123. Here, the prompt generation unit 123 generates a prompt for being input to the base model BM. The prompt is, for example, a prompt accompanying the target image. The prompt may be a predetermined prompt or may be generated according to the target image TI, an input from the user, or the like. To give a more specific example, the prompt may be any of various prompts such as grid point prompt, language prompt, rectangular prompt, and mask prompt. As an example, the base model BM according to the present example generates the one or the plurality of second attention regions with reference to the target image TI and the prompt accompanying the target image TI. Other processes are similar to the configuration example and processing example 1 described above, and thus repetitive description will be omitted. Also with the configuration of the present example, it is possible to cause the first generation unit 11 to efficiently learn by using the knowledge based on the pre-learned base model BM. In the present example, it is possible to suitably limit the attention region by using a prompt according to the purpose.

### Specific Configuration Example and Processing Example 5

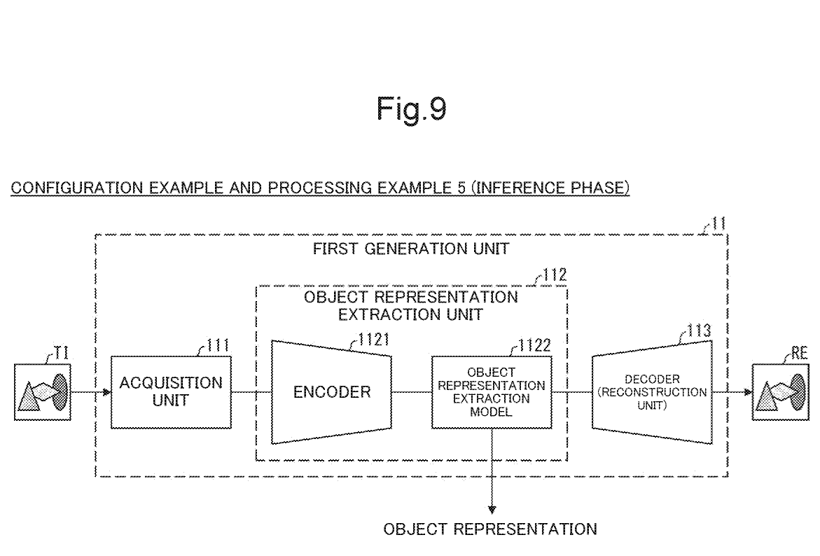

Subsequently, a specific configuration example and processing example 5 of the information processing apparatus 1A will be described with reference to FIG. 9. The present example is a specific configuration example and processing example of the information processing apparatus 1A in the inference phase. FIG. 9 is a diagram illustrating the specific configuration example and processing example of the information processing apparatus 1A according to the present example.

As illustrated in FIG. 9, in the inference phase, first, a target image TI as an inference target is acquired by the acquisition unit 111. As an example, the target image TI is captured by the camera group 70 illustrated in FIG. 3. However, this does not limit the present example.

The target image TI acquired by the acquisition unit 111 is supplied to the encoder 1121.

The object representation extraction model (extraction model) 1122 learned by any process of the processing examples 1 to 4 extracts one or a plurality of object representations OR with reference to the output of the encoder 1121. As an example, the extracted object representation is supplied to the output information generation unit 16 and included in the output information. The output information including the object representation is supplied to the monitoring device 60 as an example, and is referred to in the monitoring process. The information output in the inference phase is not limited to the above example, and a configuration in which the reconstructed image RE generated by the decoder 113 with reference to the object representation is also included in the output image may be made.

According to the above configuration, it is possible to suitably extract the object representation from the target image TI by using the extraction model that is efficiently learned by using the knowledge of the pre-learned base model BM.

### Supplementary Note Matters of Second Example Embodiment

The present example embodiment is not limited to the examples described above. As an example, a pre-learned model can be used as at least one of the encoder 1121, the object representation extraction model (extraction model) 1122, and the decoder (reconstruction unit) 113. As an example, a model pre-learned by large-scale learning data is used as at least one of the encoder 1121, the object representation extraction model 1122, and the decoder 113, and then the learning process may be advanced by transferring the knowledge of the base model BM as described in the above processing example. As described above, by starting the learning process from the pre-learned model capable of roughly estimating an object region, it is possible to accurately specify the correspondence relationship of the attention region and to more efficiently advance the learning.

For example, a technique of detecting an object from a target image is known, as disclosed in JP 2023-104705 A. As another technique developed from JP 2023-104705 A, a technique of extracting a representation (object representation) of an object included in a target image from the target image and performing various predictions, estimations, and the like with reference to the object representation has also been developed. In such a technique of extracting an object representation, it takes time to learn a model for extracting an object, which is a problem.

According to an exemplary aspect of the present disclosure, there is an exemplary effect that it is possible to cause a model for extracting an object to efficiently learn.

### Third Example Embodiment

A third example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment.

That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100B

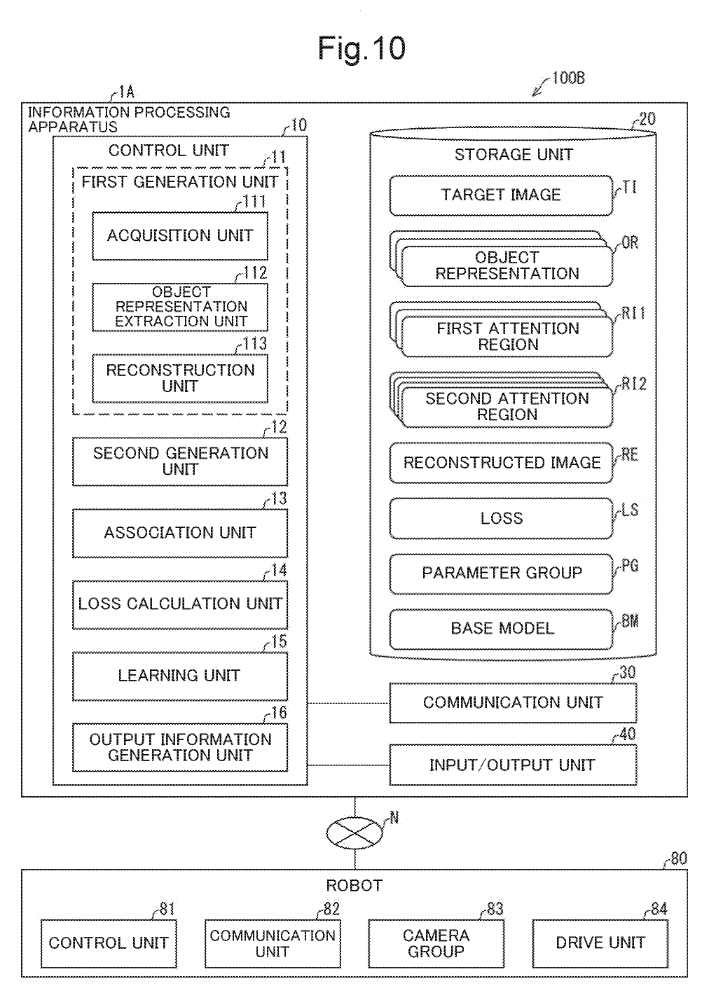

A configuration of an information processing system 100B according to the present example embodiment will be described with reference to FIG. 10. FIG. 10 is a block diagram illustrating the configuration of the information processing system 100B. As illustrated in FIG. 10, the information processing system 100B includes an information processing apparatus 1A and a robot 80 connected to the information processing apparatus 1A via a network N. Since the information processing apparatus 1A and the network N are similar to those of the first example embodiment, repetitive description will be omitted.

### Robot 80

As illustrated in FIG. 10, the robot 80 includes a control unit 81, a communication unit 82, a camera group 83, and a drive unit 84. The camera group 83 includes one or a plurality of cameras that capture a region where the robot 80 is active. The drive unit 84 includes a robot arm, a wheel, and the like driven based on control by the control unit 81.

The communication unit 82 supplies an image captured by the camera group 83 to the information processing apparatus 1A via the network N. The communication unit 82 receives an object representation extracted from the image from the information processing apparatus 1A via the network N, and supplies the object representation to the control unit 81.

The control unit 81 supplies an image obtained by capturing an image of one or a plurality of target objects to the information processing apparatus 1A via the communication unit 82, and controls the drive unit 84 with reference to an object representation extracted from the image by the information processing apparatus 1A. As an example, the control unit 81 executes hidden region estimation of the world model, future prediction processing, and the like with reference to the object representation acquired via the communication unit 82, and learns and plans the control of the robot arm.

### Information Processing Apparatus 1A

Although partially described above, in the present example embodiment, an image captured by the camera group 83 is supplied to the information processing apparatus 1A, and is referred to as the target image TI in at least one of the learning phase and the inference phase described in the second example embodiment.

In the inference phase, the information processing apparatus 1A extracts the object representation from the target image TI by an inference process using the image captured by the camera group 70 as the target image TI. The extracted object representation is supplied to the robot 80 and referenced to control the drive unit 84.

### Implementation Example by Software

Some or all of the functions of the information processing apparatuses 1 and 1A (hereinafter, also referred to as “each of the above apparatuses”) may be implemented by hardware such as an integrated circuit (IC chip) or may be implemented by software.

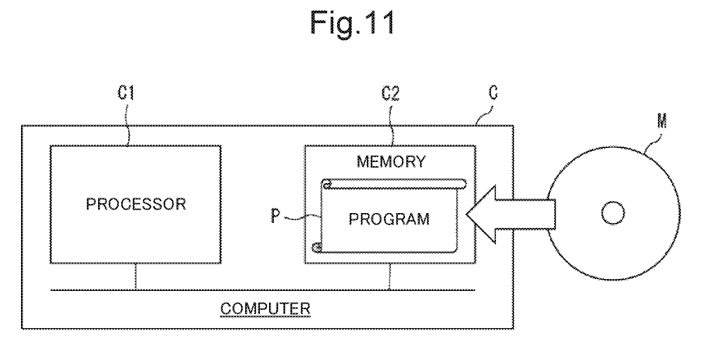

In the latter case, each of the above devices is implemented by, for example, a computer that executes a command of a program as software for implementing each function. An example of such a computer (which will be referred to as a computer C hereinafter) is illustrated in FIG. 11. FIG. 11 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes it, thereby implementing the functions of each of the above devices.

Examples of the processor C1 may include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 may include a flash memory, a hard disk drive (HDD), a solid state drive (SSD), and a combination thereof.

The computer C may further include a random access memory (RAM) for loading the program P at the time of execution and temporarily storing various types of data. The computer C may further include a communication interface for exchanging data with another device. The computer C may further include an input/output interface for connecting input/output devices such as a keyboard, a mouse, a display, a printer, and the like.

The program P may be recorded in a non-transitory tangible recording medium M readable by the computer C. Examples of such a recording medium M may include a tape, a disk, a card, a semiconductor memory, and a programmable logic circuit.

The computer C may obtain the program P via such a recording medium M. The program P may be transmitted via a transmission medium. Examples of such a transmission medium may include a communication network and a broadcast wave. The computer C may also obtain the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Note Matter A

The present disclosure includes techniques described in the following Supplementary Notes. However, the present disclosure is not limited to the techniques described in the following Supplementary Notes, and various modifications may be made within the scope described in the claims.

### Supplementary Note A1

An information processing apparatus including:

first generation means for extracting an object representation of each object included in a target image and generating one or a plurality of first attention regions based on the object representation;

second generation means for generating one or a plurality of second attention regions from the target image by using a pre-learned model;

association means for estimating a correspondence relationship between the first attention region and the second attention region;

loss calculation means for calculating a loss with reference to the first attention region and the second attention region relevant to each other; and

learning means for causing the first generation means to learn with reference to the loss.

### Supplementary Note A2

The information processing apparatus according to Supplementary Note A1, in which

the first generation means includes

object representation extraction means for extracting an object representation of each object with reference to the target image, and

reconstruction means for reconstructing each object with reference to the object representation of each object, and

the learning means updates at least a parameter included in the object representation extraction means with reference to the loss.

### Supplementary Note A3

The information processing apparatus according to Supplementary Note A2, in which the object representation extraction means generates the first attention region.

### Supplementary Note A4

The information processing apparatus according to Supplementary Note A2, in which the reconstruction means generates the first attention region.

### Supplementary Note A5

The information processing apparatus according to Supplementary Note A2, in which

the object representation extraction means includes

an encoder to which the target image is input, and

an extraction model that extracts the object representation of each object with reference to an output of the encoder.

### Supplementary Note A6

The information processing apparatus according to any one of Supplementary Notes A1 to A5, in which

the association means calculates a similarity between each of the one or the plurality of first attention regions and each of the one or the plurality of second attention regions, and estimates a correspondence relationship between the first attention region and the second attention region with reference to the similarity.

### Supplementary Note A7

The information processing apparatus according to any one of Supplementary Notes A1 to A5, in which

a value of the loss calculated by the loss calculation means is set to be smaller as a degree of difference between the first attention region and the second attention region is smaller.

### Supplementary Note A8

The information processing apparatus according to any one of Supplementary Notes A1 to A5, in which

the second generation means includes attention region estimation means for estimating the one or the plurality of second attention regions with reference to an output of the pre-learned model to which the target image has been input.

### Supplementary Note A9

An information processing method including:

by one or a plurality of processors,

extracting an object representation of each object included in a target image by using an extraction model and generating one or a plurality of first attention regions based on the object representation;

generating one or a plurality of second attention regions from the target image by using a pre-learned model;

estimating a correspondence relationship between the first attention region and the second attention region;

calculating a loss with reference to the first attention region and the second attention region relevant to each other; and

causing the extraction model to learn with reference to the loss.

### Supplementary Note A10

A program for causing a computer to function as an information processing apparatus, the program for causing the computer to function as:

first generation means for extracting an object representation of each object included in a target image and generating one or a plurality of first attention regions based on the object representation;

second generation means for generating one or a plurality of second attention regions from the target image by using a pre-learned model;

association means for estimating a correspondence relationship between the first attention region and the second attention region;

loss calculation means for calculating a loss with reference to the first attention region and the second attention region relevant to each other; and

learning means for causing the first generation means to learn with reference to the loss.

### Supplementary Note A11

The information processing apparatus according to any one of Supplementary Notes A1 to A5, in which

the second generation means generates the one or the plurality of second attention regions with reference to the target image and a prompt accompanying the target image.

What is claimed is:

1. An information processing apparatus comprising:
one or more memories storing instructions; and
one or more processors configured to execute the instructions to:
generate one or a plurality of first attention regions based on an object representation of each object included in a target image, the object representation extracted by using an extraction model;
generate one or a plurality of second attention regions from the target image by using a pre-learned model;
estimate a correspondence relationship between the first attention region and the second attention region;
calculate a loss with reference to the first attention region and the second attention region relevant to each other; and
cause the extraction model to learn with reference to the loss.

2. The information processing apparatus according to claim 1, wherein the one or more processors are configured to execute the instructions to:
extract the object representation with reference to the target image by using the extraction model;
reconstruct each object with reference to the object representation of each object; and
update at least a parameter included in the extraction model with reference to the loss.

3. The information processing apparatus according to claim 2, wherein the extracting includes generating the first attention region.

4. The information processing apparatus according to claim 2, wherein the reconstructing includes generating the first attention region.

5. The information processing apparatus according to claim 2, wherein the one or more processors are configured to execute the instructions to:
extract the object representation by using an encoder to which the target image is input, and the extraction model that extracts the object representation of each object with reference to an output of the encoder.

6. The information processing apparatus according to claim 1, wherein the one or more processors are configured to execute the instructions to:
calculate a similarity between each of the one or the plurality of first attention regions and each of the one or the plurality of second attention regions; and
estimate a correspondence relationship between the first attention region and the second attention region with reference to the similarity.

7. The information processing apparatus according to claim 1, wherein the one or more processors are configured to execute the instructions to:
calculate the loss by using a loss function that generates a smaller loss value the smaller the degree of difference between the first attention region and the second attention region.

8. The information processing apparatus according to claim 1, wherein the one or more processors are configured to execute the instructions to:
estimate the one or the plurality of second attention regions with reference to an output of the pre-learned model to which the target image has been input.

9. The information processing apparatus according to claim 1, wherein the one or more processors are configured to execute the instructions to:
generate the one or the plurality of second attention regions with reference to the target image and a prompt accompanying the target image.

10. An information processing method comprising:
by one or a plurality of processors,
generating one or a plurality of first attention regions based on an object representation of each object included in a target image, the object representation extracted by using an extraction model;
generating one or a plurality of second attention regions from the target image by using a pre-learned model;
estimating a correspondence relationship between the first attention region and the second attention region;
calculating a loss with reference to the first attention region and the second attention region relevant to each other; and
causing the extraction model to learn with reference to the loss.

11. A non-transitory recording medium recording a program for causing a computer to execute a process comprising:
generating one or a plurality of first attention regions based on an object representation of each object included in a target image, the object representation extracted by using an extraction model;
generating one or a plurality of second attention regions from the target image by using a pre-learned model;
estimating a correspondence relationship between the first attention region and the second attention region;
calculating a loss with reference to the first attention region and the second attention region relevant to each other; and
causing the extraction model to learn with reference to the loss.
